(19) United States
(12) Patent Application Publication
(10) Pub. No.: US 2015/0088561 A1
(43) Pub. Date: Mar. 26, 2015

(54) REMOTE GIFTING AT EVENT VENUES VIA NETWORKED MOBILE COMPUTING DEVICES

(71) Applicant: FragMob, LLC, San Diego, CA (US)

(72) Inventor: Jade Makani Roberge Charles, San Diego, CA (US)

(73) Assignee: FragMob, LLC, San Diego, CA (US)

(21) Appl. No.: 14/033,377

(22) Filed: Sep. 20, 2013

(51) Int. Cl. G06Q 10/02; G06Q 30/06

(52) U.S. Cl. CPC G06Q 10/02; G06Q 30/0601
USPC 705/5

(57) ABSTRACT

A method on a web server for facilitating gifting of goods or services over a communications network is disclosed. The method includes receiving a message including a unique ticket identifier from an event venue, responsive to scanning of a first user's ticket at the event venue, accessing a ticket record in an attached database, transmitting a message to one or more other users, wherein the message identifies the first user and the event venue, and wherein the message includes a link that, when activated, provides a graphical user interface that allows another user to purchase a product or service for pick-up by the first user at the event venue. The method further includes processing electronic payment information of the other user, generating an electronic coupon for redemption of the product or service at the event venue, and transmitting the electronic coupon to the first user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field of electronic commerce and, more specifically, the present invention relates to the field of gifting activities using mobile computing devices.

### BACKGROUND OF THE INVENTION

Gift giving is an important part of U.S. commerce. Throughout a typical year, consumers are faced with multiple occasions that require the giving of gifts. Examples include birthdays, graduations, anniversaries, baptisms, holidays, and religious observances. The U.S. Department of Commerce estimates that an average holiday shopping season results in over $500 billion in sales. When all gift giving occasions in an average year are considered, U.S. sales attributed to giving gifts amount to over a trillion U.S. dollars in sales.

Conventionally, gifts are purchased in person by a gift giver and presented to the recipient either personally or via regular mail or courier. In more recent years, with the rise in popularity of the Internet, gift givers are increasingly purchasing gifts online and having the gifts shipped to the recipient. A less common option is to have a third person, such as a personal shopper, purchase a gift on behalf of a gift giver and present the gift to the recipient. Thus, a variety of ways exist for purchasing gifts and relaying them to the recipient of the gift.

One of the drawbacks associated with conventional gift giving activities involves the time gap and location disparity between the purchase of the gift and the presentation of the gift to the gift recipient. Conventionally, a gift giver purchases a gift at a brick and mortar store and then physically transports the gift for presentation to the gift recipient at a later time. When the Internet is used, a gift giver purchases a gift on a web site and then a delivery provider or courier physically delivers the gift to the gift recipient at a later time. The time gap and the disparity in location between the time/location of purchase of the gift and the time/location the gift is presented can take away from the impact of the gift and its utility to the gift recipient. This can be a disadvantage in situations where the gift is meant to be relevant at the time of purchase or meant to be used or enjoyed at or near the time of purchase.

Therefore, what is needed is a system and method for improving the problems with the prior art, and more particularly for a more expedient and efficient method and system for facilitating gift giving activities.

### BRIEF SUMMARY OF THE INVENTION

In one embodiment, a method on a web server for facilitating gifting of goods or services over a communications network is disclosed. The method includes receiving, via the communications network, a message, including a unique ticket identifier, from an event venue, wherein the unique ticket identifier has been garnered via scanning of a first user's ticket at the event venue, accessing a ticket record in an attached database using the unique ticket identifier, wherein the ticket record includes a unique identifier for the first user, transmitting, via the communications network, a message to one or more other users, wherein the message includes the unique identifier for the first user, and an identifier for the event venue, and wherein the message includes a link that, when activated, provides a graphical user interface that allows another user to purchase a product or service for pick-up by the first user at the event venue, responsive to receiving a request from another user who has activated the link, providing, via the communications network, the graphical user interface configured for allowing the other user to purchase the product or service for pick-up by the first user at the event venue, processing electronic payment information of the other user to effectuate payment for the product or service for pick-up by the first user at the event venue, and generating an electronic coupon configured for redemption of the product or service at the event venue, and transmitting the electronic coupon to a mobile computing device of the first user via the communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the network architecture of a system for facilitating gifting of goods or services over a communications network, in accordance with one embodiment.

FIG. 2A is a block diagram showing the data flow pertaining to a user of the system for gifting of goods or services over a communications network according to one embodiment.

FIG. 2B is a block diagram showing the data flow pertaining to a friend of the user with regard to the system for gifting of goods or services over a communications network, according to one embodiment.

FIG. 3A is a flow chart depicting the general control flow of a process for facilitating gifting of goods or services over a communications network, according to one embodiment.

FIG. 3B is a diagram depicting the data flow and control flow between the main players of the process for facilitating gifting of goods or services over a communications network, according to one embodiment.

FIG. 4 is a block diagram of a system including an example computing device and other computing devices.

### DETAILED DESCRIPTION OF THE INVENTION

The disclosed embodiments improve upon the problems with the prior art by providing a system that allows a friend of a user that is currently attending an event to purchase a gift for that user at the event, without being present at the event. The friend is notified of the user's presence at the event via, for example, text message, email message or a social network. In response, the friend may purchase a gift, such as a drink, t-shirt or book, or a service, such as a massage, for the user online, which results in the user receiving an electronic coupon on his mobile device, which may be redeemed at the event venue for the gift. Therefore, the disclosed embodiments reduce or eliminate the need for the purchasing friend to be present at the event venue in order to give a gift to the user at the event venue. This is advantageous for users and their friends, as it provides greater flexibility in gift giving activities and bridges the temporal and geographic gap that may exist between a user at an event venue and a friend at home, who desires to give a gift to the user. An additional benefit of the disclosed embodiments is the immediate transmission of the coupon to the recipient's mobile device and the immediate confirmation of the use of the coupon, or the redemption of the gift, via, for example, text message, email message or a social network.

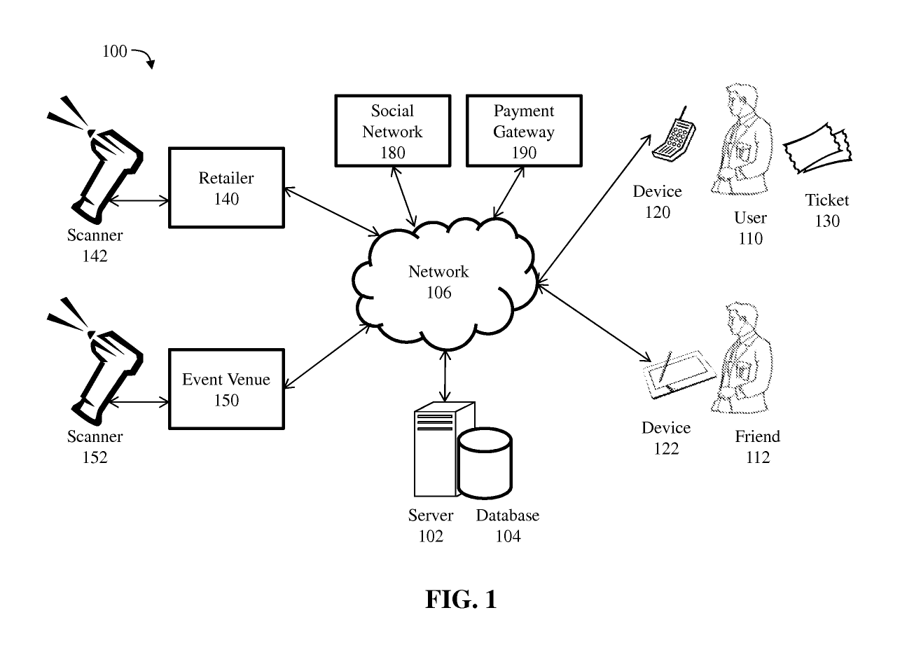

Referring now to the drawing figures in which like reference designators refer to like elements, there is shown in FIG. 1 an illustration of a block diagram showing the network architecture of a system 100 and method for facilitating gift giving activities over a communications network in accordance with one embodiment. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating gift giving activities between users.

FIG. 1 includes mobile computing devices 120 and 122, which may be smart phones, mobile phones, tablet computers, handheld computers, laptops, or the like. Mobile computing devices 120 and 122 correspond to a user 110 and a friend 112 of the user 110. The term friend is used loosely to designate any other person in relation to the user 110. User 110 may also possess one or more conventional paper tickets 130 for use at the event venue 150.

FIG. 1 further shows that server 102 includes a database or repository 104, which may be a relational database comprising a Structured Query Language (SQL) database stored in a SQL server. Devices 120, 122 and 150 may also each include their own database. The repository 104 serves data from a database, which is a repository for data used by server 102 and devices 120, 122, 150 during the course of operation of the disclosed embodiments. Database 104 may be distributed over one or more nodes or locations that are connected via network 106.

The database 104 may include a user record for each user 110 or 112. A user record may include: contact/identifying information for the user (name, address, telephone number(s), email address, etc.), information pertaining to electronic tickets associated with the user, contact/identifying information for friends of the user, electronic payment information for the user, information pertaining to the purchases made by the user, sales transaction data associated with the user, etc. A user record may also include a unique identifier for each user, a residential address for each user, the current location of each user (based on location-based services from the user's mobile computer) and a description of past electronic tickets purchased by each user. A user record may further include demographic data for each user, such as age, sex, income data, race, color, marital status, etc. A user record may also include contact information (email address, name, address, telephone number, etc.) or a unique identifier for one or more friends or acquaintances of the user.

Sales transaction data may include one or more product/service identifiers (such as SKUs), one or more product/service amounts, buyer contact/identifying information, event information, event venue information and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a ticket record for each ticket or electronic ticket. A ticket record may include: a unique ticket identifier, contact/identifying information for the user or users (unique identifier for the user, name, address, telephone number(s), email address, etc.) associated with the electronic ticket, information pertaining to the number of users associated with the electronic ticket, event information, performer data, team data, event venue information, seat data, row data, section data, date and time data, additional services data (such as concierge, VIP service or valet parking services) and a data element that indicates whether an electronic ticket has been used or redeemed. A ticket record may also include contact information (email address, name, address, telephone number, etc.) or a unique identifier for one or more friends or acquaintances of the user associated with the ticket record.

In another embodiment, a ticket record may include a unique code for each ticket, such any one of a unique alphanumeric value, a matrix barcode, a linear barcode or a unique image. An electronic ticket is defined as a representation of the corresponding ticket record, on a mobile computing device of a user. In one embodiment, an electronic ticket is a file or other data structure which may reside on the mobile device of a user, wherein, when opened or activated, displays the unique code, and/or any of the data, of a ticket record. In another embodiment, an electronic ticket is the unique code in the ticket record for a ticket. In yet another embodiment, an electronic ticket or a ticket record can be accessed by a user to print a printed ticket 130 (shown in FIG. 1), which displays the unique code, and/or any of the data, of a ticket record. The term ticket is used to refer to a paper ticket, such as ticket 130, an electronic ticket, as defined above, the data of a ticket record, or any subset thereof.

The database 104 may include a coupon record for each electronic coupon. A coupon record may include: a unique coupon identifier, contact/identifying information for the user associated with the electronic coupon and/or the user who purchased the electronic coupon, a description of goods or services that may be redeemed with the coupon, an amount of goods or services that may be redeemed, an amount of money that was paid for the coupon, a monetary redemption amount for the coupon, event information, event venue information, date and time data, and a data element that indicates whether an electronic coupon has been used or redeemed. In another embodiment, a coupon record may include a unique code for each coupon. An electronic coupon is defined as a representation of the corresponding coupon record, which may reside on a mobile computing device of a user. In one embodiment, an electronic coupon is a file or other data structure which may reside on the mobile device of a user, wherein, when opened or activated, displays the unique code, and/or any of the data, of a coupon record.

FIG. 1 shows an embodiment of the present invention wherein networked computing devices 120, 122 interact with server 102 and repository 104 (as well as entities 140, 150, 180 and 190) over the network 106. Server 102 includes a software engine that delivers applications, data, program code and other information to networked computing devices 120, 122 (as well as entities 140, 150, 180 and 190). It should be noted that although FIG. 1 shows only the networked computers 102, 120, 122, 140, 150, 180 and 190, the system of the disclosed embodiments supports any number of networked computing devices connected via network 106. Further, server 102, entities 140, 150, 180 and 190, and devices 120, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 120, 122, retailer 140, event venue 150, payment authority 190 or social network 180. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 110 or 112 for electronic tickets, or the like. In the course of a sales transaction, server 102 may interface with payment authority 190 to effectuate payment. In one embodiment of the present invention, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc. FIG. 1 further shows social network 180, which may be a third party social network that provides a web based social networking service. A social networking service consists of a representation of each user (often a profile), his/her social links, and a variety of additional services, such as a means for users to interact over the Internet, including e-mail and instant messaging. A social networking service may further allow users to share ideas, pictures, posts, activities, events, and interests with others.

FIG. 1 also shows event venue 150, which represents a location for an event, such as a music venue, a sport venue, a theater, an arena, a stage, an amphitheater, an outdoor concert structure, stadium, bandshell, bandstand, concert hall, opera house, nightclub, discotheque, park, restaurant, bar, pub, sports complex, etc. The event venue 150 may also represent the information technology infrastructure, including servers and computers, which are used by the event venue 150 to manage electronic tickets and the entrance of attendees into the venue. Scanner 152 is shown as part of the event venue 152. Workers at an event venue are often seen holding handheld scanners that are used to scan electronic tickets upon entrance. Scanner 152 may be an infrared scanner, a bar code scanner, an image scanner, barcode reader, biometric scanner, RFID scanner, NFC scanner, etc. Lastly, FIG. 1 shows a retailer 140, which may be a brick and mortar retailer or seller of goods and services that is located at or near the event venue 150. In one example, retailer 140 may be a restaurant or a food provider at the event venue 150.

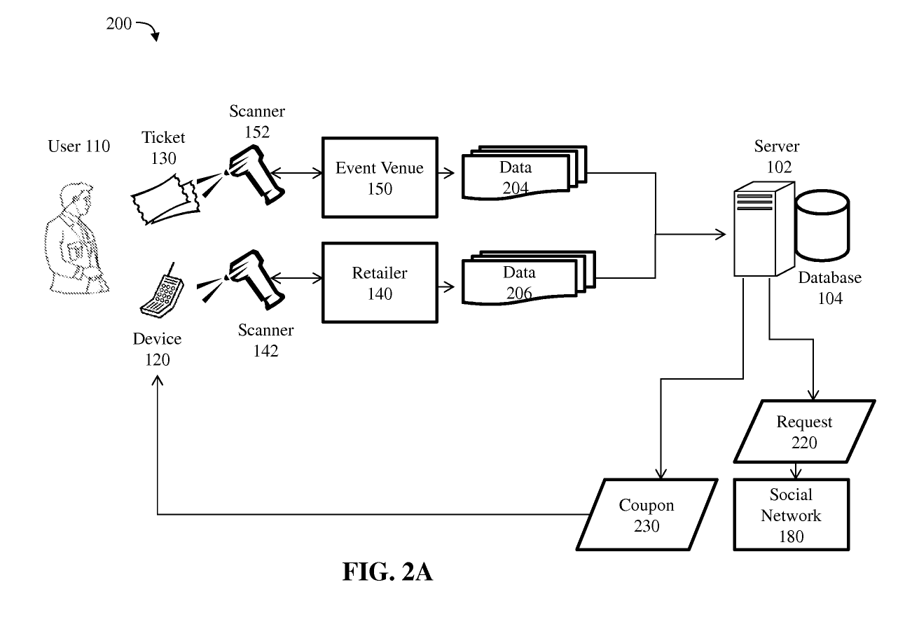

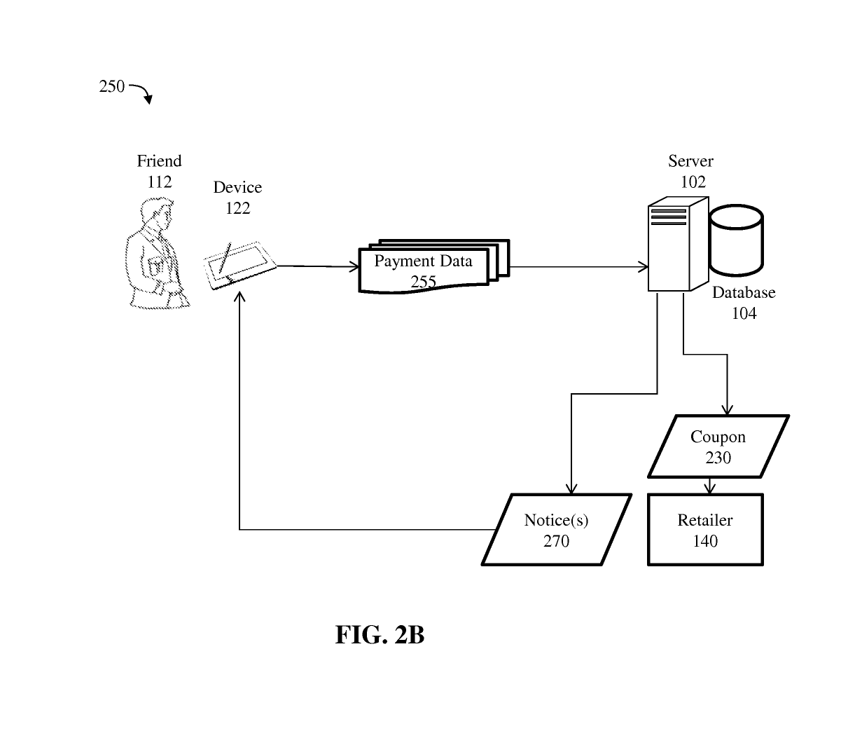

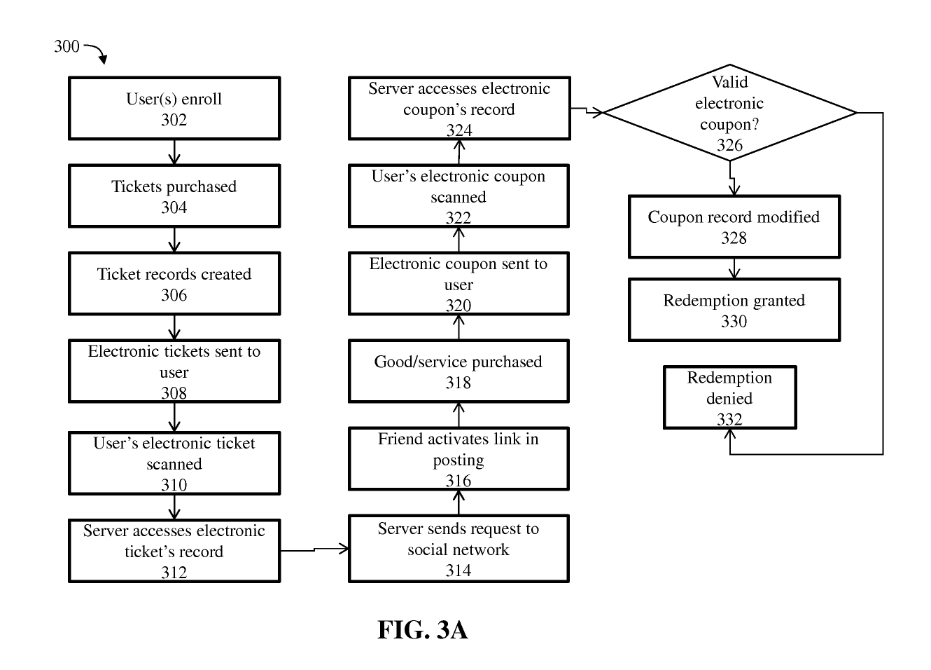

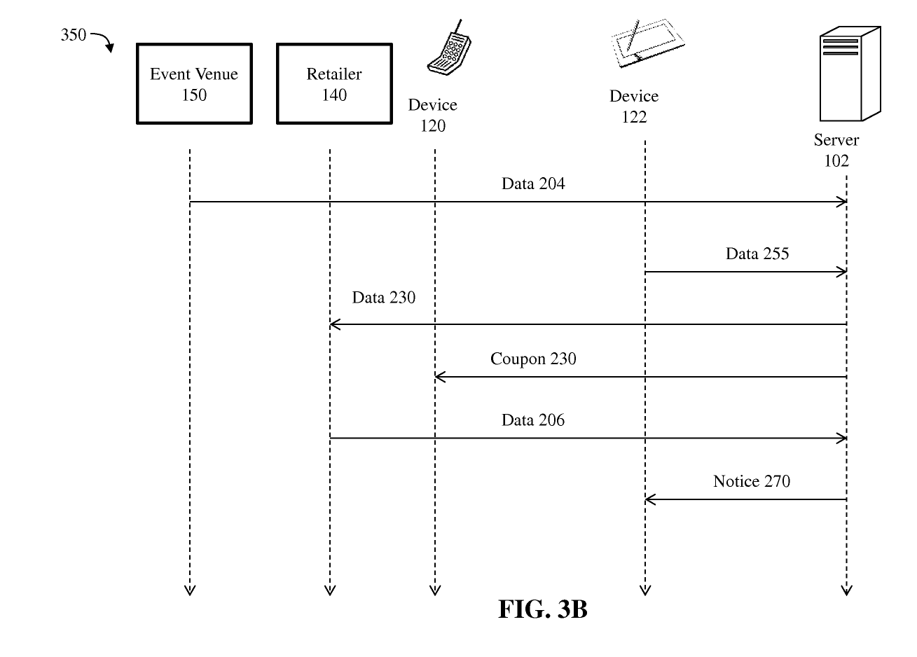

The process of gift giving over a communications network will now be described with reference to FIGS. 2A through 3B below. FIGS. 2A through 3B depict the data flow and control flow in the process for facilitating gift giving over a communications network 106, according to one embodiment. The process of the disclosed embodiments begins with optional step 302 (see flowchart 300), wherein the users 110 and/or 112 may enroll or register with server 102, social network 180 and/or event venue 150. In the course of enrolling or registering, user 110 may enter data into his device 120 by manually entering data into a mobile application via keypad, touchpad, or via voice. In the course of enrolling or registering, the user 110 may enter any data that may be stored in a user record, as defined above. Also in the course of enrolling or registering, the server 102, social network 180 and/or event venue 150 may generate a user record for each registering user and store the user record in an attached database, such as database 104.

Subsequently, in step 304, the user 110 purchases tickets to attend an event at event venue 150. The user 110 may purchase the tickets utilizing his mobile computing device 120. In the next step 306, the server 102 may generate and store in database 104 one or more ticket records for the tickets purchased by the user 110. Also in step 306, the server 102 may generate a unique code for each ticket, such any one of a unique alphanumeric value, a matrix barcode, a linear barcode or a unique image. The unique code for each ticket may be stored in the corresponding ticket record for that ticket. In one alternative, step 306 is only executed if the payment authority 190 sends a verification message to the server 102 verifying that payment has been effectuated in step 304. Next, in step 308, server 102 generates one or more electronic tickets, corresponding to the tickets purchased by the user 110 in step 304 and corresponding to the ticket records created in step 306, and transmits the electronic tickets to the mobile device 120 of the user 110. Also in step 308, the server 102 may optionally transmit the electronic tickets (and/or the corresponding ticket records, or a portion thereof) to the event venue 150.

In one embodiment, in step 308, the server 102 may transmit the electronic tickets to the mobile device 120 of the user 110: 1) via a network protocol, such as HTTP, to the IP address of the mobile device 120 of the user 110, as the IP address is stored in the ticket record(s) associated with the electronic tickets 210 or the user record of the user 110, or in response to an HTTP request from the mobile device 120 of the user 110 (wherein the HTTP request includes the IP address of the device 120), or 2) via text message to the telephone number of the mobile device 120 of the user 110, as the telephone number is stored in the ticket record(s) associated with the electronic tickets 210 or the user record of the user 110, or in response to a text message from the mobile device 120 of the user 110 (wherein the text message includes the telephone number of the device 120).

In step 310, the user 110 attends the event and presents the electronic ticket (displayed on his device 120, for example), or his printed ticket 130, for scanning by a scanner 152 at the event venue 150. In this step, the scanner 152 may read data 204 from the electronic ticket or the printed ticket 130, which is transmitted from the event venue 150 to the server 102 (see diagram 200). The data 204 may be any data included in the electronic ticket or the printed ticket 130, such as a unique ticket identifier.

In step 312, the server 102 receives the data 204 and accesses in database 104 the ticket record that corresponds to the data 204, such as the unique ticket identifier. The ticket record that is accessed also defines the user 110 that is associated with the ticket that was scanned at the event venue 150. In step 314, the server reads from the accessed ticket record (or a file or record to which the ticket record points or refers), the unique identifier of the user 110 or another identifier for user 110 (such as a name, social network login data, handle, etc.) and event information, such as the event venue, event location, the event time, performer data, etc. Also in step 314, the server 102 transmits (via network 106) to the social network 180 a request 220 to publish a posting that identifies the user 110 and the event information that was read, so as inform friends of the user 110 (or others who have access to the profile and/or feed data of the user 110) on the social network 180 that the user 110 is attending said event. For example, the server 102 may request that the social network 180 publish a posting indicating that “John Smith has just arrived at the White Arena in New York to listen to the New York Symphony.”

In one embodiment, the request 220 also includes a link or Uniform Resource Locator (URL) that, when activated, leads to a web site or web page where a friend 112 may purchase a good or service for the user 110 at the event venue 150. The link or URL may also include text that advertises or prompts the friend 112 to purchase a good or service for pick-up by the user 110 at the event venue 150. For example, the text may read: “Click here to buy John Smith a glass of wine at the White Arena tonight!” In another embodiment, the link or URL, when activated, may execute a call to a mobile application that is currently executing on the mobile device 122 of the friend, wherein the mobile application displays a graphical user interface wherein the friend 112 may purchase a good or service for the user 110 at the event venue 150. Thus, request 220 includes a request that the social network 180 publishes the included link, as well as the advertising text.

In step 316, the social network 180 publishes the posting that was requested to be posted by the server 120, and the posting is viewable by friends of the user 110 or others who have access to the profile and/or feed data of the user 110 on the social network 180. Also in step 316, the friend 112 reads the posting, such as on his mobile device 122, and clicks on the link provided in the posting. Subsequently, the friend 112 is presented with a graphical user interface or web page wherein the friend 112 may purchase a good or service for the user 110 at the event venue 150.

In one alternative to steps 314 and 316 described above, in alternative step 314, the server reads data from the accessed ticket record, as described above, or data from another record linked to the ticket record (such as a user record), wherein that data includes contact information (email address, telephone number, unique messaging address, etc.) for friends or acquaintances (such as friend 112) of the user 110. Also in step 314, the server 102 transmits (via network 106) to the one or more friends or acquaintances of the user 110 a message (such as an email, instant message, SMS text message, etc.) that identifies the user 110 and the event information that was read, so as to inform the friends of the user 110 that the user 110 is attending said event. For example, the message may state “John Smith has just arrived at the White Arena in New York to listen to the New York Symphony.” The message may include the same link or URL described above. In alternative step 316, the friend 112 reads the message, such as on his mobile device 122, and clicks on the link provided in the posting. Subsequently, the friend 112 is presented with a graphical user interface or web page wherein the friend 112 may purchase a good or service for the user 110 at the event venue 150.

Returning the flow chart 300 of FIG. 3, subsequently, in step 318, the friend 112 may purchase the good or service utilizing his mobile computing device 122. In the course of purchasing the good or service, friend 112 may enter electronic payment information (i.e., data 255) into his device 122 by manually entering data into a mobile application via keypad, touchpad, or via voice (see diagram 250). Friend 112 may alternatively enter data 255 into his device 122 by using Radio Frequency Identification (RFID), or Near Field Communication (NFC). RFID is the use of a wireless non-contact system that uses radio-frequency electromagnetic fields to transfer data from one node to another. NFC is a set of standards for smart-phones and similar devices to establish radio communication by bringing nodes into close proximity.

Alternatively, friend 112 may also enter data 255, or a portion thereof, into his device 122 by swiping a purchase card through a card reader communicatively coupled with the device 122. A card reader is a data input device that reads data from a card-shaped storage medium. One example of a card reader is a magnetic card reader, which reads magnetic stripe cards, such as credit cards. A mobile card reader is a card reader that is communicatively coupled with a mobile computing device. In one embodiment, upon reading any purchase card data, the device 122 immediately encrypts the purchase card data that was read, so as to produce encrypted purchase card data. In this embodiment, the encrypted purchase card data is transmitted to the server 102 or payment authority 190 in data 255.

Also in step 318, the data 255, or a portion thereof, may be transmitted to payment authority 190 for processing. The payment authority 190 processes the electronic payment information of the friend 112 and verifies whether payment has been effectuated. If so, the payment authority 190 may send a verification message to the server 102 thereby verifying that the payment has been effectuated. The data 255 may be stored in association with the user record for friend 112 or user 110.

In step 320, the purchase of the good or service has been completed, and the server 102 generates an electronic coupon 230 and transmits it to the device 120 of the user 110 over the network 106. The user 110 receives the electronic coupon 230 and displays it on his device 120. Optionally, in step 320, the server 102 transmits the electronic coupon 230, or any data from the corresponding coupon record, to the retailer 140.

In step 322, the user 110 visits the retailer 140 located at or near the event venue 150 and presents the electronic coupon (displayed on his device 120, for example), for scanning by a scanner 142 at the retailer 140. In this step, the scanner 142 may read data 206 from the electronic coupon, which is transmitted from the retailer 140 to the server 102 (see diagram 200). The data 206 may be any data included in the electronic coupon, such as a unique coupon identifier.

In step 324, the server 102 receives data 206 and accesses the coupon record in the database 104 corresponding to the electronic coupon identified by the data 206 (such as the unique coupon identifier). The server 102 then determines, in step 326, whether the electronic coupon is still valid, i.e., has not been used yet. Specifically, the server 102 opens the coupon record and checks the data element that indicates whether an electronic coupon has been used or redeemed. If the data element indicates that the electronic coupon has not been used or redeemed, then the control flows to step 328. If the data element indicates that the electronic coupon has been used or redeemed, then the control flows to step 332 wherein a denial message is transmitted to the retailer 140 and/or scanner 142 and the user 110 is denied redemption of the gift or service corresponding to the electronic coupon.

In step 328, the server 102 then modifies the data in the coupon record that was accessed to reflect that the coupon has been used by the user 110 to obtain his product or service at the event venue 150, and is therefore no longer valid. In one embodiment, the server 102 opens the coupon record and modifies the data element that indicates whether an electronic coupon has been used or redeemed with a data element that confirms that the electronic coupon has been used or redeemed. Subsequently, control flows to step 330 wherein an acceptance message is transmitted to the retailer 140 and/or scanner 142 and the user 110 is allowed to obtain the product or service corresponding to the electronic coupon.

In one embodiment, step 330 optionally includes the server 102 generating a notice 270 (such as an email message, an SMS text message, a message, etc.) that indicates that the user 110 has redeemed the electronic coupon 230 at the retailer 140. The notice 270 may then be transmitted to the device 122 of friend 112 or to the social network 180. Alternatively, the server 102 may send to social network 180 a request to publish a posting that identifies the user 110 and data from the coupon record, so as inform friends of the user 110 (or others who have access to the profile and/or feed data of the user 110) on the social network 180 that the user 110 has picked up his good or service. For example, the server 102 may request that the social network 180 publish a posting indicating that “John Smith has just picked up his glass of wine at the White Arena in New York.”

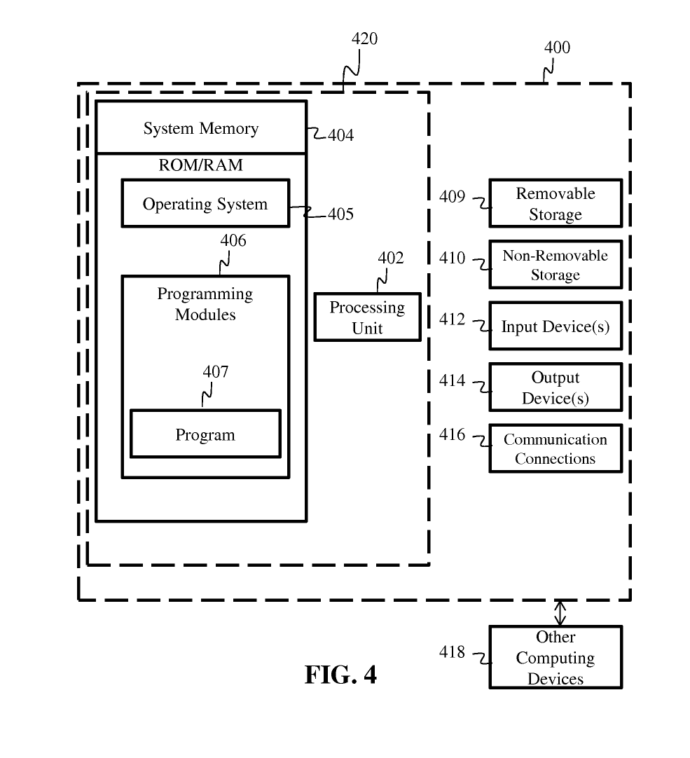

FIG. 4 is a block diagram of a system including an example computing device 400 and other computing devices. Consistent with the embodiments described herein, the aforementioned actions performed by 102, 120, 122, 140, 150 and 180 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2A-3B above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2A-3B above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a web server for facilitating gifting of goods or services over a communications network, comprising:
receiving, by the web server, via the communications network, a message, including a unique ticket identifier, from an event venue, wherein the unique ticket identifier has been garnered via scanning of a first user's ticket at the event venue during an event;
accessing, by the web server, a ticket record in an attached database using the unique ticket identifier, wherein the ticket record includes a unique identifier for the first user;
transmitting, by the web server, via the communications network, a message to one or more other users, wherein the message includes the unique identifier for the first user, and an identifier for the event venue, and wherein the message includes a link that provides a graphical user interface configured for providing a payment process for purchasing a product or service for pick-up by the first user at the same event venue where the first user's ticket was scanned and during said event;
responsive to receiving a request from another user who has activated the link, providing, by the web server, via the communications network, the graphical user interface configured for providing a payment process for purchasing the product or service for pick-up by the first user at the event venue and during said event;
processing, by the web server electronic payment information of the other user to effectuate payment for the product or service for pick-up by the first user at the event venue and during said event; and
generating, by the web server an electronic coupon configured for redemption in exchange for the product or service at the same event venue where the first user's ticket was scanned and during said event, and transmitting the electronic coupon to a mobile computing device of the first user via the communications network.

2. The method of claim 1, wherein the step of receiving the message, including the unique ticket identifier, from the event venue further comprises receiving the message, further including a time stamp, from the event venue, wherein the time stamp corresponds to a time of scanning of the first user's ticket at the event venue.

3. The method of claim 2, wherein the step of transmitting the message to one or more other users further comprises transmitting the message to one or more other users, wherein the message further includes text advertising an opportunity to purchase the product or service for pick-up by the first user at the event venue, and wherein the message comprises a text message or an email message.

4. The method of claim 3, wherein the steps of receiving electronic payment information from the other user and processing the electronic payment information further comprise:
receiving, via the communications network, login data that has been entered by the other user into the graphical user interface;
accessing a user record in the attached database using the login data, wherein the user record includes purchase card data that has been previously stored in the database by the other user; and
processing the purchase card data to effectuate payment for the product or service for the first user.

5. The method of claim 4, wherein the step of generating an electronic coupon further comprises:
generating an electronic coupon comprising any one of a unique alphanumeric value, a matrix barcode, a linear barcode or a unique image.

6. The method of claim 5, wherein the step of generating an electronic coupon further comprises:
storing a coupon record in the attached database, wherein the coupon record includes the electronic coupon, a unique identifier for the electronic coupon, a description of the product or service for which the electronic coupon is configured for redeeming, and an amount of money that was paid by the other user for the electronic coupon.

7. The method of claim 6, further comprising:
transmitting the coupon record to a retailer with a point of sale location at the event venue, via the communications network.

8. The method of claim 7, further comprising:
receiving from the retailer, via the communications network, a message indicating that the first user has redeemed the electronic coupon at the point of sale location at the event venue.

9. The method of claim 8, further comprising:
transmitting, via the communications network, a message to the other user, wherein the message includes text indicating that the first user has redeemed the electronic coupon at the point of sale location at the event venue.

10. A method on a web server for facilitating gifting of goods or services over a communications network, comprising:
storing, by the web server, a ticket record in an attached database, wherein the ticket record includes a unique identifier for a user;
receiving, by the web server, via the communications network, a message, including the unique ticket identifier, from an event venue, wherein the unique ticket identifier has been garnered via scanning of the user's ticket at the event venue during an event;
accessing, by the web server, the ticket record in the attached database using the unique ticket identifier;
transmitting, by the web server, via the communications network, a message to a social network, wherein the message includes: 1) a request to publish a posting including the unique identifier for the user and an identifier for the event venue, wherein the posting is viewable by friends of the user, and 2) a request to publish a link that provides a graphical user interface configured for providing a payment process for purchasing a product or service for pick-up by the user at the same event venue where the first user's ticket was scanned and during said event;
responsive to receiving a request from a friend who has activated the link, providing, by the web server, via the communications network, the graphical user interface configured for providing a payment process for purchasing the product or service for pick-up by the user at the event venue and during said event;
receiving, by the web server, via the communications network, login data that has been entered by the friend into the graphical user interface;
accessing, by the web server, a user record in the attached database using the login data, wherein the user record includes purchase card data that has been previously stored in the database;
processing, by the web server, the purchase card data to effectuate payment for the product or service for the user; and
generating, by the web server, an electronic coupon configured for redemption in exchange for the product or service at the same event venue where the first user's ticket was scanned and during said event, and transmitting the electronic coupon to a mobile computing device of the user via the communications network.

11. The method of claim 10, wherein the step of processing the purchase card data further comprises:
encrypting the purchase card data so as to produce encrypted purchase card data; and
transmitting the encrypted purchase card data, and a request for payment of a monetary amount corresponding to the product or service, to a payment gateway via the communications network.

12. The method of claim 11, wherein the step of processing the purchase card data further comprises:
receiving, via the communications network, a confirmation of payment of the monetary amount corresponding to the product or service.

13. A web server for facilitating gifting of goods or services over a communications network, comprising:
a database for storing ticket records, wherein each ticket record includes a unique identifier for a first user and a telephone number for a mobile computing device of the first user;
a network interface device communicatively coupled with the communications network; and
a processor configured for:
receiving, via the network interface device, a message, including a unique ticket identifier, from an event venue, wherein the unique ticket identifier has been garnered via scanning of a first user's ticket at the event venue and during an event;
accessing a ticket record in the database using the unique ticket identifier;
transmitting, via the communications network, a message to one or more other users, wherein the message includes the unique identifier for the first user, and an identifier for the event venue, and wherein the message includes a link that provides a graphical user interface configured for providing a payment process for purchasing a product or service for pick-up by the first user at the same event venue where the first user's ticket was scanned and during said event;
responsive to receiving a request from another user who has activated the link, providing, via the network interface device, the graphical user interface configured for allowing the other user to purchase the product or service for pick-up by the first user at the event venue and during said event;
processing the electronic payment information of the other user to effectuate payment for the product or service for pick-up by the first user at the event venue and during said event; and
generating an electronic coupon configured for redemption in exchange for the product or service at the same event venue where the first user's ticket was scanned and during said event, and transmitting the electronic coupon to the telephone number of the mobile computing device of the user via the network interface device.

14. The web server of claim 13, wherein the message from the event venue further comprises a time stamp corresponding to a time of scanning of the user's ticket at the event venue.

15. The web server of claim 14, wherein the message transmitted to one or more other users further includes text advertising an opportunity to purchase the product or service for pick-up by the first user at the event venue, and wherein the message comprises a text message or an email message.

16. The web server of claim 15, wherein the electronic coupon further comprises any one of a unique alphanumeric value, a matrix barcode, a linear barcode or a unique image.

17. The web server of claim 16, wherein the database is further configured for storing coupon records, wherein each coupon record includes the electronic coupon, a unique identifier for the electronic coupon, a description of the product or service for which the electronic coupon is configured for redeeming, and an amount of money that was paid by the friend for the electronic coupon.
